(19) United States
(12) Patent Application Publication
(10) Pub. No.: US 2023/0415233 A1
(43) Pub. Date: Dec. 28, 2023

(54) THREE-DIMENSIONAL PRINTING

(71) Applicant: Hewlett-Packard Development Company, L.P., Spring, TX (US)

(72) Inventors: Aja Pariante HARTMAN, Palo Alto, CA (US); John Samuel Dilip JANGAM, Palo Alto, CA (US)

(21) Appl. No.: 18/038,176

(22) PCT Filed: Dec. 1, 2020
(86) PCT No.: PCT/US2020/070834

§ 371 Date: May 22, 2023

(51) Int. Cl. B22F 10/14; B22F 12/10

(52) U.S. Cl. CPC B22F 10/14; B22F 12/10; B33Y 10/00

(57) ABSTRACT

The present disclosure relates to a method of 3D printing a 3D printed object. The 5 method comprises printing a layer of a build material composition comprising a solution of a metal salt and a liquid carrier. An interconnected metal network is formed by reducing the metal salt in the printed build material composition. A further layer of the build material composition is printed over the interconnected metal network, and the metal salt in the further layer is reduced to form a further 10 interconnected metal network over the underlying interconnected metal network to provide a porous structure to the 3D printed object. By layering and joining interconnected metal networks one on top of another, porous regions may be constructed within the 3D printed part.

### BACKGROUND

Three-dimensional (3D) printing is an additive printing process used to make three-dimensional objects from a digital model. Some 3D printing techniques may be considered additive processes because they involve the application of successive layers of material.

### BRIEF DESCRIPTION OF THE DRAWING

Features of examples of the present disclosure will become apparent by reference to the following detailed description and drawings.

FIGS. 1 and 2 show, by way of illustration, how an example heating agent may be used in Example 3 to selectively reduce metal salt in selective portions of a printed layer of build material composition;

FIG. 3 shows the exotherm detected with compositions I and II by differential scanning calorimetry (DSC) in Example 3; and

FIG. 4 shows the X-ray diffraction patterns of compositions I and II of Example 3 before and after reduction of the copper (II) salt.

### DETAILED DESCRIPTION

The present disclosure relates to a method of 3D printing a 3D printed object. The method comprises printing a layer of a build material composition comprising a solution of a metal salt and a liquid carrier. An interconnected metal network is formed by reducing the metal salt in the printed build material composition. A further layer of the build material composition is printed over the interconnected metal network, and the metal salt in the further layer is reduced to form a further interconnected metal network over the underlying interconnected metal network to provide a porous structure to the 3D printed object. By layering and joining interconnected metal networks one on top of another, porous regions may be constructed within the 3D printed part.

The present disclosure also relates to a 3D printed object obtainable by such a method. At least part of the structure of the 3D printed object may be porous. The porosity may be provided by a three-dimensional network of pores formed by reducing metal salt to metal in the successively printed layers of build material.

A 3D object may be manufactured by 3D printing by selectively applying a binding agent to a particulate build material. The binding agent may cause the portions of build material treated with the binding agent to coalesce to form a layer of the 3D printed part. Because the build material is in the form of a particulate material, the porosity of the structure can be difficult to control, as voids formed in one layer may be at least partially filled when particulate build material is applied in subsequent layers. In the present disclosure, porosity can be controlled by printing a build material composition as a liquid. Accordingly, to print the porous region(s) of the 3D printed object, it may not be necessary to use a particulate build material. Once the build material is printed, the metal salt in the build material composition is reduced, forming an interconnected metal network from the metal produced as a result of the reduction reaction. A porous structure may be built by forming interconnected metal networks layer-upon-layer. By controlling the print pattern and/or print density of the layers, it may be possible to control the porosity of the 3D printed object.

In some examples, the metal salt of the build material composition may be a transition metal salt, for instance, a copper salt. Any suitable metal salt may be employed. For example, the salt may be an inorganic or organic salt. The salt may comprise at least one anion selected from the group consisting of hydroxide, carbonate, sulfate, nitrate, acetate, formate, borate, chloride, bromide, and combinations thereof. In one example, the salt is copper nitrate. The salt may be a hydrated metal salt. For example, the salt may be hydrated copper nitrate.

In some examples, the build material composition may comprise a reducing agent. The reducing agent may also act as a solvent and/or humectant in the build material composition. In some examples, the reducing agent is a reducing solvent.

The reducing solvent may be a lactam and/or a polyol. Examples of suitable lactams include lactams and polylactams, for instance, 2-pyrrolidinone, 1-(2-hydroxyethyl)-2-pyrrolidone and polyvinylpyrrolidone. Examples of suitable polyols include diols and triols. Examples include ethylene glycol, propylene glycol, glycerol, glycerol ethoxylate, ethylhydroxypropanediol, 1,2-butanediol, diethylene glycol and dipropylene glycol.

Where the build material comprises a reducing agent, the reducing agent may be present in an amount of 3 to 20 weight % of the build material composition. The reducing agent may be present in an amount of 3 to 18 weight % or 4 to 15 weight %, for example, 5 to 12 weight % or 6 to 10 weight % of the build material composition.

In addition or instead of including a reducing agent in the build material composition, a reducing agent may be selectively applied to printed areas of the build material composition once the build material composition has been printed. The reducing agent may be applied as, for example, a separate ink composition. Such reducing agents may also act as a solvent and/or humectant. In some examples, the reducing agent is a reducing solvent. As with reducing solvents that may be included in the build material composition, the reducing solvent may be a lactam and/or a polyol. Examples of suitable lactams include lactams and polylactams, for instance, 2-pyrrolidinone, 1-(2-hydroxyethyl)-2-pyrrolidone and polyvinylpyrrolidone. Examples of suitable polyols include diols and triols. Examples include ethylene glycol, propylene glycol, glycerol, glycerol ethoxylate, ethylhydroxypropanediol, 1,2-butanediol, diethylene glycol and dipropylene glycol.

In some examples, reduction of the metal salt may be initiated by heating the printed build material composition to a temperature of 100 to 300° C. In some examples, the temperature may be at least 120° C., for example, 125 to 140° C. Heating may facilitate drying of the printed build material composition, for example, by driving the evaporation of water from the printed build material composition. Heating may also facilitate reduction of the metal salt of the build material composition.

In some examples, heating may facilitate reduction of the metal salt by the reducing agent, if present. In examples where a reducing solvent is employed, the reducing solvent may have a boiling point higher than, for example, about 180 degrees C. By selecting a reducing solvent with an appropriate boiling point, some reducing solvent may remain even after the printed build material composition is dried. In some examples, this reducing solvent may act as a barrier that reduces the rate or risk of metal re-oxidation of any interconnected metal network formed during the reduction of the metal salt.

Heating may be accomplished by heating the printed build material composition. This heating may be carried out by e.g. heating the print platform or varying the temperature of the printer. To provide resolution to the printed build material composition, it may be possible to selectively cool portions of the printed build material composition, for example, by selectively applying a detailing agent (e.g. an aqueous solution) to portions of the printed build material composition to avoid or lessen the extent of reduction of the metal salt in these areas.

Alternatively or additionally, heating may be carried out by using a heating agent. The heating agent may be a composition comprising a radiation absorber and a liquid carrier. In some examples, the method further comprises applying a heating over or adjacent to at least one of the layers of printed build material composition. The heating agent may comprise a radiation absorber and a liquid carrier. The heating agent may be irradiated with electromagnetic radiation to cause the radiation absorber to generate heat for the reduction of metal salt. An example of a suitable radiation absorber is carbon black.

The heating agent may be selectively applied over a portion of at least one of the layers. The heating agent may facilitate heating and reduction of the metal salt in specific areas of the printed build material composition. By applying the heating agent, for instance, by inkjet printing, it may be possible to selectively reduce metal salt in selected areas of the printed build material with a high degree of resolution.

In some examples, a detailing agent may be employed, for instance, in combination with the heating agent to selectively provide specific areas of the build material with the resolution required to selectively effect reduction of the metal salt at particular regions of the printed build material composition.

In some examples, the metal salt may be reduced in an inert atmosphere. For example, the metal salt may be reduced in a reduced oxygen atmosphere. This may reduce the risk of the metal re-oxidizing as or after it is formed during reduction of the metal salt.

In some examples, the metal salt is reduced in the presence of oxygen (e.g. air). The presence of oxygen can cause at least some of the metal in the interconnected metal network to oxidize as or after the metal salt is reduced. For instance, in the case of copper, the copper may re-oxidize to copper oxide. Copper oxide may form as a coating on at least part of the interconnected copper network. In some examples, the method further comprises thermally treating the interconnected metal network to reduce any metal oxide to metal.

In some examples, the method further comprises incorporating material to at least partially fill the porous structure.

### Build Material Composition

As mentioned above, the build material composition comprises a metal salt. The metal salt may be an organic or inorganic metal salt. The metal salt may comprise a metal selected from the group consisting of aluminum, magnesium, copper, zinc, iron, nickel, manganese, cobalt, molybdenum, chromium, tin, vanadium, and combinations thereof. The metal salt may comprise an anion selected from the group consisting of hydroxide, carbonate, sulfate, nitrate, acetate, formate, borate, chloride, bromide, and combinations thereof.

In some examples, the metal salt may be a copper salt. The copper salt may be an inorganic or organic metal salt.

In some examples, the copper salt may be a hydroxide, a carbonate, a sulfate, a nitrate, an acetate, a formate, a borate, a chloride and/or a bromide. In one example, the copper salt is copper nitrate.

In some examples, the metal salt may be a hydrated metal salt. The hydrated metal salt may be selected from the group consisting of hydrated copper nitrate, hydrated iron nitrate, hydrated nickel nitrate, hydrated manganese nitrate, hydrated cobalt nitrate, hydrated iron acetate, and combinations thereof.

In some examples, the hydrated metal salt may be hydrated copper nitrate. For instance, the hydrated metal salt may be hydrated copper (II) nitrate. In some examples, the hydrated metal salt may be copper (II) nitrate trihydrate.

Where a hydrated metal salt is used, the hydrated metal salt may have a a dehydration temperature of from 100 to about 250° C. In some examples, dehydration temperature as used in this disclosure may be the temperature by which all, or nearly all, of the water molecules in the hydrated metal salt have either been removed by evaporation or reacted to form other compounds. Dehydration may be progressive. Dehydration may occur in multiple discrete steps as the hydrated metal salt is heated.

In some examples where a hydrated metal salt is used, the dehydration temperature may be more than about 100° C., or more than about 110° C., or more than about 120° C., or more than about 130° C., or more than about 140° C., or more than about 150° C., or more than about 160° C., or more than about 170° C., or more than about 180° C., or more than about 190° C., or more than about 200° C., or more than about 210° C., or more than about 220° C., or more than about 230° C., or more than about 240° C., or less than about 250° C., or less than about 240° C.

In some examples where a hydrated metal salt is used, the dehydration temperature may be less than about 230° C., or less than about 220° C., or less than about 210° C., or less than about 200° C., or less than about 190° C., or less than about 180° C., less than about 170° C., or less than about 160° C., or less than about 150° C., or less than about 140° C., or less than about 130° C., or less than about 120° C., or less than about 110° C.

In some examples where a hydrated metal salt is used, the dehydration temperature may be from about 100° C. to about 240° C., or from about 100° C. to about 230° C., or from about 100° C. to about 220° C., or from about 100° C. to about 210° C., or from about 100° C. to about 200° C., or from about 100° C. to about 190° C., or from about 100° C. to about 180° C., or from about 100° C. to about 170° C., or from about 100° C. to about 160° C., or from about 100° C. to about 150° C., or from about 100° C. to about 140° C., or from about 100° C. to about 130° C., or from about 100° C. to about 120° C., or from about 100° C. to about 110° C.

In some examples, the metal salt may be present in the build material composition at about 10 weight % to up to 100 weight % of the saturation concentration of the metal salt in water at 25 degrees C. For example, the metal salt may be present in the build material composition at about 30 weight % to up to 99 weight % of the saturation concentration, for example, at about 25 weight % up to 95 weight % of the saturation concentration.

In some examples, the metal salt may be present in an amount of at least about 5 weight % of the total weight of the build material composition, for example, at least about 10 weight %, at least about 15 weight %, at least about 20 weight %, at least about 25 weight %, at least about 30 weight %, at least about 35 weight % or at least about 40 weight %.

In some examples, the metal salt may be present in an amount of at most about 70 weight % of the total weight of the build material composition, for example, at most about 65 weight % or at most about 60 weight %.

In some examples, the metal salt may be present in an amount of from about 5 wt % to about 70 wt % based on the total weight of the build material composition, or from about 10 wt % to about 65 wt % based on the total weight of the build material composition, or from about 15 wt % to about 60 wt % based on the total weight of the build material composition, or from about 20 wt % to about 55 wt % based on the total weight of the build material composition, or from about 25 wt % to about 55 wt % based on the total weight of the build material composition, or from about 30 wt % to about 50 wt % based on the total weight of the build material composition, or from about 35 wt % to about 50 wt % based on the total weight of the build material composition, or from about 40 wt % to about 50 wt % based on the total weight of the build material composition.

In some examples, the metal salt may be copper nitrate (e.g. hydrated copper (11) nitrate or copper (11) nitrate trihydrate). The amount of copper nitrate in the build material composition may be at least about 30 weight %, for example, at least about 35 weight %. The amount of hydrated copper nitrate in the build material composition may be at most about 58 weight %, for example, at most about 56 weight %. In some examples, the amount of hydrated copper nitrate may be from about 35 to about 58 weight %, for instance, from about 38 to about 58 weight %.

As mentioned above, the build material composition also comprises water. Water may be the liquid vehicle of the build material composition. Water may be present in an amount of at least about 40 weight %, for example, at least about 42 weight %, at least about 45 weight %, at least about 50 weight % or at least about 55 weight %.

In some examples, water may be present in an amount of about 40 to about 70 weight %, for instance, about 42 to about 67 weight %, about 45 to about 65 weight %, about 50 to about 65 weight % or about 55 to about 60 weight %.

The build material composition may comprise a reducing agent. In some examples, the reducing agent may be a reducing solvent.

Where a reducing solvent is used, the reducing solvent is present in an amount of at least about 2 weight % of the build material composition. In some examples, the reducing agent may be present in an amount of at least about 3 weight % of the build material composition.

In some examples, the reducing solvent may be present in an amount of at most about 20 weight % of the build material composition. In some examples, the reducing agent may be present in an amount of at most about 18 weight % or at least about 15 weight % of the build material composition.

In some examples, the reducing solvent may be present in an amount of about 2 to about 20 weight %, for instance, about 3 to about 18 weight % of the build material composition. In some examples, the reducing solvent may be present in an amount of about 3 to about 15 weight %, for instance, about 4 to about 14 weight % or about 5 to about 12 weight % of the build material composition.

The reducing solvent may be a lactam and/or a polyol. Examples of suitable lactams include lactams and polylactams, for instance, 2-pyrrolidinone, 1-(2-hydroxyethyl)-2-pyrrolidone and polyvinylpyrrolidone. Examples of suitable polyols include diols and triols. Examples include ethylene glycol, propylene glycol, glycerol, glycerol ethoxylate, ethylhydroxypropanediol, 1,2-butanediol, diethylene glycol and dipropylene glycol.

In some examples, where the reducing solvent is 2-pyrrolidinone, the 2-pyrrolidinone is not present in an amount of 5 weight % or in an amount of 7.5 weight % of the build material composition.

The reducing solvent may have a boiling point of at least about 135 degrees C., for instance, at least about 140 degrees C. The reducing solvent may have a boiling point of at most about 400 degrees C., for example, at most about 380 degrees C. In some examples, the reducing solvent may have a boiling point of about 135 to about 400 degrees C., for instance, 140 to 380 degrees C. The reducing solvent may be a lactam having a boiling point in the range of about 140 to about 260 degrees C., for instance, about 200 to about 250 degrees C. The reducing solvent may be a polyol having a boiling point in the range of about 170 to about 400 degrees C., for instance, about 180 to about 380 degrees C. or about 200 to about 300 degrees C. In some examples, the reducing solvent may be a polyol having a boiling point of about 225 to about 250 degrees C.

In some examples, the build material composition may comprise surfactant. Where present, suitable surfactants include non-ionic surfactants. Examples of suitable surfactants include surfactants based on acetylenic diol chemistry (e.g., SURFYNOL® SEF from Air Products and Chemicals, Inc.), fluorosurfactants (e.g., CAPSTONE® fluorosurfactants from DuPont, previously known as ZONYL FSO), and combinations thereof. In other examples, the surfactant may be an ethoxylated low-foam wetting agent (e.g., SURFYNOL® 440 or SURFYNOL® CT-111 from Air Products and Chemical Inc.) or an ethoxylated wetting agent and molecular defoamer (e.g., SURFYNOL® 420 from Air Products and Chemical Inc.). Still other suitable surfactants include non-ionic wetting agents and molecular defoamers (e.g., SURFYNOL® 104E from Air Products and Chemical Inc.) or water-soluble, non-ionic surfactants (e.g., TERGITOL™ TMN-6 or TERGITOL™ 15-S-7 from The Dow Chemical Company). In other examples, the surfactant may be a sulfonated surfactant, for example, a disulfonated surfactant, such as an alkyldiphenyloxide disulfonate (e.g. DOWFAX™ 2A1). In some examples, it may be useful to utilize a surfactant having a hydrophilic-lipophilic balance (HLB) less than 10.

When a surfactant is used, the total amount of surfactant(s) in the build material composition may range from about 0 to about 3 weight % based on the total weight of the build material composition. The total amount of surfactant(s) in the build material composition may be less than about 3 weight %, for example, less than about 2 weight %, less than about 1 weight %, less than about 0.5 weight %, less than about 0.2 weight % or less than 0.1 weight % based on the total weight of the build material composition.

Other components may also be present in the build material composition. Examples include antimicrobial agent(s), anti-kogation agent(s), viscosity modifier(s), pH adjuster(s) and/or sequestering agent(s).

Suitable antimicrobial agents include biocides and fungicides. Example antimicrobial agents may include the NUOSEPT™ (Troy Corp.), UCARCIDE™ (Dow Chemical Co.), ACTICIDE® M20 (Thor), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., Bardac® 2250 and 2280, Barquat® 50-65B, and Carboquat® 250-T, all from Lonza Ltd. Corp.), and an aqueous solution of methylisothiazolone (e.g., Kordek® MLX from Dow Chemical Co.). The biocide or antimicrobial may be added in any amount ranging from about 0.05 wt % to about 0.5 wt % (as indicated by regulatory usage levels) with respect to the total weight of the build material composition.

In some examples, the biocide and/or antimicrobial component may be present in an amount of less than 0.1 weight %, for example, less than about 0.08 weight %, or less than 0.005 weight %.

As mentioned above, an anti-kogation agent may be included in the build material composition. Kogation refers to the deposit of dried ink (e.g. build material composition) on a heating element of a thermal inkjet printhead. Anti-kogation agent(s) is/are included to assist in preventing the buildup of kogation. Examples of suitable anti-kogation agents include oleth-3-phosphate (e.g., commercially available as CRODAFOS™ O3A or CRODAFOS™ N-3 acid from Croda), or a combination of oleth-3-phosphate and a low molecular weight (e.g., <5,000) polyacrylic acid polymer (e.g., commercially available as CARBOSPERSE™ K-7028 Polyacrylate from Lubrizol). Whether a single anti-kogation agent is used or a combination of anti-kogation agents is used, the total amount of anti-kogation agent(s) in the build material composition may range from greater than 0.2 wt % to about 0.8 wt % based on the total weight of the build material composition. In an example, the oleth-3-phosphate is included in an amount ranging from about 0.2 wt % to about 0.6 wt %, and the low molecular weight polyacrylic acid polymer is included in an amount ranging from about 0.005 wt % to about 0.03 wt %.

Sequestering agents, such as EDTA (ethylene diamine tetra acetic acid), may be included to eliminate the deleterious effects of heavy metal impurities, and buffer solutions may be used to control the pH of the build material composition. In some examples, the sequestering agent may be present in an amount of less than 2 weight %, for example, less than about 0.2 weight %, or less than 0.1 weight %.

In some examples, reduction of the metal salt may be initiated by heating the printed build material composition to a temperature of 100 to 300° C. In some examples, the temperature may be at least 120° C., for example, 125 to 140° C.

By heating the printed build material composition, any water in the printed build material composition may evaporate. Heating may also facilitate reduction of the metal salt of the build material composition. As explained above, reduction of the metal salt may facilitate the formation of the interconnected metal network. The interconnected metal network may be metallic and formed from the metal produced as the metal salt in the printed build material is reduced. However, during the 3D printing process, part of the interconnected metal network may be re-oxidized under the print conditions, for example, because of the presence of oxygen in the surroundings and/or because of the elevated temperatures encountered in the printer. This may form a coating of metal oxide over at least part of the interconnected metal network.

Where the metal salt is a copper salt, the interconnected metal network may be an interconnected copper network. However, as discussed above, during the 3D printing process, part of the interconnected copper network may be re-oxidized under the print conditions, for example, because of the presence of oxygen in the surroundings and/or because of the elevated temperatures encountered in the process. This may form a coating of copper oxide over at least part of the interconnected metal network. Any copper oxide may be reduced, for example, during a subsequent thermal treatment step.

Heating may be accomplished by e.g. heating the print platform or varying the temperature of the printer. The latter may be accomplished through the use of heating lamps positioned over the print platform. To provide resolution to the printed build material composition, it may be possible to selectively cool portions of the printed build material composition, for example, by selectively applying a detailing agent (see below) to portions of the printed build material composition to avoid or lessen the extent of reduction of the metal salt in these areas.

Alternatively or additionally, heating may be carried out by using a heating agent. The heating agent may be a composition comprising a radiation absorber and a liquid carrier. In some examples, the method further comprises applying a heating over or adjacent to at least one of the layers of printed build material composition. The heating agent comprises a radiation absorber and a liquid carrier. When the applied heating agent is irradiated with electromagnetic radiation, the radiation absorber generates heat for the reduction of metal salt.

### Heating Agent

In the present disclosure, the method may comprise selectively applying a heating agent to or adjacent the printed build material composition and exposing at least part of the heating agent to radiation.

The heating agent can include a radiation absorber. The radiation absorber or pigment can absorb electromagnetic radiation and convert that radiation into heat. The heating agent can be selectively applied to or adjacent to the areas of the printed build material that are intended to be reduced.

The heating agent can be applied, for example, by printing with a fluid or inkjet printhead. Accordingly, the heating agent can be applied with precision to selected areas to form a layer of the 3D printed object. After applying the heating agent, the printed layer of build material can be irradiated with radiant energy. The radiation absorber can absorb this energy and convert it to heat, thereby heating any of the printed build material composition in contact or adjacent to the radiation absorber of the heating agent. An appropriate amount of radiant energy can be applied so that enough heat is generated to cause the metal salt in the build material composition to be reduced. This can facilitate the formation of an interconnected metal network.

The radiation absorber of the heating agent may be any suitable absorber. Examples of suitable absorbers include UV absorbers, infrared absorbers and near infrared absorbers. In some examples, infrared absorbers or near infrared absorbers are employed. In some examples, the infrared absorber or near infrared absorber may absorb electromagnetic radiation in the range of 700 nm to 1 mm. In many cases, the infrared absorber or near infrared absorber can have a peak absorption wavelength in the range of 800 nm to 1400 nm.

In some examples, the absorber can be carbon black, tungsten bronze, molybdenum bronze, conjugated polymer, aminium dye, tetraaryldiamine dye, cyanine dye, phthalocyanine dye, dithiolene dye, metal phosphate, metal silicate or mixtures thereof.

The absorber may be a near infrared absorbing dye. Examples of absorbing dyes include aminium dyes, tetraaryldiamine dyes, cyanine dyes, pthalocyanine dyes, dithiolene dyes, and others.

In further examples, the absorber can be a near-infrared absorbing conjugated polymer such as poly(3,4-ethylenedioxythiophene)-poly(styrenesulfonate) (PEDOT:PSS), a polythiophene, poly(p-phenylene sulfide), a polyaniline, a poly(pyrrole), a poly(acetylene), poly(p-phenylene vinylene), polyparaphenylene, or combinations thereof. As used herein, “conjugated” refers to alternating double and single bonds between atoms in a molecule. Thus, “conjugated polymer” refers to a polymer that has a backbone with alternating double and single bonds.

Other examples of radiation absorbers or pigments can include phosphates having a variety of counterions such as copper, zinc, iron, magnesium, calcium, strontium, the like, and combinations thereof. Specific examples of phosphates can include M₂P₂O₇, M₄P₂O₉, M₅P₂O₁₀, M₃(PO₄)₂, M(PO₃)₂, M₂P₄O₁₂, and combinations thereof, where M represents a counterion having an oxidation state of +2, such as those listed above or a combination thereof. For example, M₂P₂O₇ can include compounds such as Cu₂P₂O₇, Cu/MgP₂O₇, Cu/ZnP₂O₇, or any other suitable combination of counterions. It is noted that the phosphates described herein are not limited to counterions having a +2 oxidation state. Other phosphate counterions can also be used to prepare other suitable radiation absorbers.

Other examples of radiation absorbers or pigments include silicates. The silicates can have the same or similar counterions as the phosphates. One non-limiting example can include M₂SiO₄, M₂Si₂O₆, and other silicates where M is a counterion having an oxidation state of +2. For example, the silicate M₂Si₂O₆ can include Mg₂Si₂O₆, Mg/CaSi₂O₆, MgCuSi₂O₆, Cu₂Si₂O₆, Cu/ZnSi₂O₆, or other suitable combination of counterions. It is noted that the silicates described herein are not limited to counterions having a +2 oxidation state. Other silicate counterions can also be used to prepare other suitable pigments.

In some examples, the absorber may comprise carbon black.

In some examples, the radiation absorber may be dissolved or dispersed in a liquid vehicle. The heating agent may be a liquid composition comprising the radiation absorber, e.g. UV absorber, near infrared absorber or infrared absorber and a liquid carrier.

The liquid carrier can include water. In some examples, an additional co-solvent may also be present. In certain examples, a high boiling point co-solvent can be included in the heating agent. The high boiling point co-solvent can be an organic co-solvent that boils at a temperature higher than the temperature of the bed of powder bed material during printing. In some examples, the high boiling point co-solvent can have a boiling point above 250° C. In still further examples, the high boiling point co-solvent can be present at a concentration of at least about 1 wt %, for example, at least about 1.5 wt % of the total weight of the heating agent. The co-solvent, where employed may be present in an amount of at most about 50 wt %, for example, at most about 40 wt %, at most about 35 wt % or at most about 30 wt %. In some examples, the co-solvent may be present in an amount of from about 1 wt % to about 40 wt % of the total weight of the heating agent.

Classes of co-solvents that can be used can include organic co-solvents including aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. Specific examples of solvents that can be used include 2-pyrrolidinone, N-methylpyrrolidone, 2-hydroxyethyl-2-pyrrolidone, 2-methyl-1,3-propanediol, tetraethylene glycol, 1,6-hexanediol, 1,5-hexanediol and 1,5-pentanediol.

A surfactant, or combination of surfactants, can also be present in the heating agent. Examples of surfactants include alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like. Other surfactants can include liponic esters such as Tergitol™ 15-S-12, Tergitol™ 15-S-7 available from Dow Chemical Company, LEG-1 and LEG-7; Triton™ X-100; Triton™ X-405 available from Dow Chemical Company; and sodium dodecylsulfate.

The amount of surfactant present in the heating agent may range from about 0.01 wt % to about 20 wt %.

Various other additives can be employed to optimize the properties of the heating agent for specific applications. Such additives can be present at from about 0.01 wt % to about 20 wt % of the heating agent. Examples of these additives are those added to inhibit the growth of harmful microorganisms. These additives may be biocides, fungicides, and other microbial agents, which can be used in ink jet formulations. Examples of suitable microbial agents include NUOSEPT® (Nudex, Inc.), UCARCIDE™ (Union carbide Corp.), VANCIDE® (R.T. Vanderbilt Co.), PROXEL® (ICI America), and combinations thereof.

Sequestering agents, such as EDTA (ethylene diamine tetra acetic acid), may be included to eliminate the deleterious effects of heavy metal impurities. Buffers may also be used to control the pH of the composition. Viscosity modifiers may also be present.

The amount of radiation absorber, e.g. UV absorber, infrared absorber or near infrared absorber, in the heating agent can vary depending on the type of absorber. In some examples, the concentration of infrared absorber or near infrared absorber in the heating agent can be from about 0.1 wt % to about 20 wt % of the heating agent. In one example, the concentration of absorber in the heating ink can be from about 0.1 wt % to about 15 wt %. In another example, the concentration can be from about 0.1 wt % to about 8 wt %. In yet another example, the concentration can be from about 0.5 wt % to about 2 wt %. In a particular example, the concentration can be from about 0.5 wt % to about 1.2 wt %.

The heating agent may be selectively applied over a portion of at least one of the layers. The heating agent may facilitate heating and reduction of the metal salt in specific areas of the printed build material composition. In some examples, a detailing agent may be employed, for instance, in combination with the heating agent to selectively provide specific areas of the build material with the resolution required to selectively effect reduction of the metal salt at particular regions of the printed build material composition.

### Detailing Agents

Where a detailing agent is used, the detailing agent can be capable of reducing the temperature of the printed build material. The detailing agent can increase selectivity between regions of printed build material where the metal salt is reduced and regions of printed build material where no reduction occurs. Thus, the detailing agent can be used to shape the interconnected metal network.

In some examples, the detailing agent can be a solvent that evaporates when it comes into contact with the printed build material at the print platform preheat temperature, thereby cooling selective portions of the printed build material through evaporative cooling. In certain examples, the detailing agent can include water, co-solvents, or combinations thereof.

Non-limiting examples of co-solvents for use in the detailing agent can include xylene, methyl isobutyl ketone, 3-methoxy-3-methyl-1-butyl acetate, ethyl acetate, butyl acetate, propylene glycol monomethyl ether, ethylene glycol mono tert-butyl ether, dipropylene glycol methyl ether, diethylene glycol butyl ether, ethylene glycol monobutyl ether, 3-Methoxy-3-Methyl-1-butanol, isobutyl alcohol, 1,4-butanediol, N,N-dimethyl acetamide, and combinations thereof.

In some examples, the detailing agent can be mostly water. In a particular example, the detailing agent can be about 85 wt % water or more. In further examples, the detailing agent can be about 95 wt % water or more. In still further examples, the detailing agent can be substantially devoid of radiation absorbers.

The detailing agent can also include ingredients to allow the detailing agent to be jetted by a fluid jet printhead. In some examples, the detailing agent can include additives such as those in the heating agent described above. These ingredients can include a liquid vehicle, surfactant, dispersant, co-solvent, biocides, viscosity modifiers, materials for pH adjustment, sequestering agents, preservatives, and so on. These ingredients can be included in any of the amounts described above.

### 3D Printing

In the method of the present disclosure, a layer of a build material composition may be printed onto a print platform. The metal salt in the printed build material composition is then reduced to form an interconnected metal network. The reduction may be initiated by heating the printed build material composition. As discussed above, this heating may be performed by heating the pint platform. Alternatively or additionally, the build material composition may be heated using heating lamps, such as tungsten halogen lamps positioned over the print platform. Alternatively or additionally, a heating agent may be printed over or adjacent to the printed build material composition and irradiated to generate the heat required to initiate or facilitate reduction of the metal salt.

It may be possible to heat each layer of printed build material to reduce the metal salt in one layer before a subsequent layer of build material is applied. Alternatively, it may be possible to print a plurality of layers of build material composition before initiating the reduction of the metal salt. For example, about 2 to layers, for instance, 2 to 6 layers of build material composition may be applied before the reduction of metal salt is initiated.

Once initiated, for example, by heating (e.g. to at least 120 degrees C.), the reduction of metal salt to metal reaction may self-propagate. The reduction reaction may be exothermic. In some examples, the high temperatures may cause re-oxidation of any metal formed to metal oxide. This oxidation may form a metal oxide coating on the interconnected metal network. In some examples, substantially all the metal formed by reduction may be re-oxidized to metal oxide This re-oxidation may be avoided or reduced, for example, by carrying out the reduction in a reduced oxygen atmosphere. Alternatively or additionally, any metal oxide formed may be reduced by e.g. exposing the metal oxide to high temperatures in a reducing atmosphere.

In some examples, after printing, the 3D object is subjected to thermal treatment. Such treatment may be performed in an oven or furnace. The temperatures employed may be dependent on the metal being printed. For example, for copper, the temperature may be from about 700° C. to about 1050° C.

In some examples, the thermal treatment may be performed for a time period ranging from about 10 minutes to about 20 hours, or at least 10 minutes, or at least 1 hour, or at least 2 hours, or at least 4 hours, or at least 10 hours, or at least hours.

The thermal treatment may be performed in a reducing atmosphere, for example, in the presence of hydrogen. In some examples, thermal treatment may be performed in the presence of hydrogen and an inert gas, for example, argon or under vacuum.

In some examples, the thermal treatment may also be used to alter the density of the resulting part. For instance, sintering may be performed to densify the resulting part.

### Example 1

In this example, a build material composition having the following composition was prepared:

| Ingredient | % w/w |
|---|---|
| 2-pyrrolidone | 7.5 |
| Alkyldiphenyloxide Disulfonate (Dowfax ™ 2A1 supplied by | 0.5 |
| Dow ® Chemical) | |
| Non-ionic fluorinated surfactant (Capstone FS-35 supplied by | 0.025 |
| ChemPoint ®) | |
| Cu(NO₃)₂ · 3H₂O | 40 |
| H₂O | Balance |

A disc-shaped layer of the build material composition was printed onto a pre-heated quartz print platform by inkjet printing. The print platform was pre-heated to 90 degrees C. The printed build material composition was then heated using heating lamps to a temperature of 150 degrees C. The copper (II) salt was reduced to copper (0) and an interconnected elemental copper network began to form. The reaction spread in a self-propagated manner to cover the entire print area. The reduction was exothermic and a peak temperature of above 300 degrees C. was recorded using a thermal imaging camera. A further disc-shaped layer of build material was printed and the process repeated layer by layer until a 100 layer disc was printed.

The high temperature exposure caused the interconnected copper network to oxidize and a black coating of copper oxide was formed over the network.

The 3D printed part was then thermally treated in a furnace in a reducing atmosphere, causing the copper oxide to reduce to copper. The following thermal treatment cycle was employed: heat at 5° C./min to 400° C., hold for 2 hours, heat at 5° C./min to 1040° C. and hold for 2 hours. The final disc was a porous disc of elemental copper.

### Example 2

In this example, a heating agent was used to generate at least some of the heat to initiate the reduction of the copper salt of the build material composition to copper. The following heating agent was used:

| Ingredient | Weight % |
|---|---|
| Carbon Black | 5 |
| 2-pyrrolidinone | 45 |
| Ink carrier comprising water, surfactant, biocide and anti- | 25 |
| kogation agent | |
| Water | 30 |

A disc-shaped layer of the build material composition of Example 1 was printed onto a pre-heated quartz print platform by inkjet printing. A disc-shaped layer of the heating agent above was applied adjacent the disc-shaped layer of build material. The heating agent was irradiated with infra-red radiation. This caused the carbon black (radiation absorber) to generate thermal energy to initiate the reduction of copper (II) to copper in the printed build material. The reduction reaction was initiated in the area of the printed build material adjacent the area of printed heating agent.

### Example 3

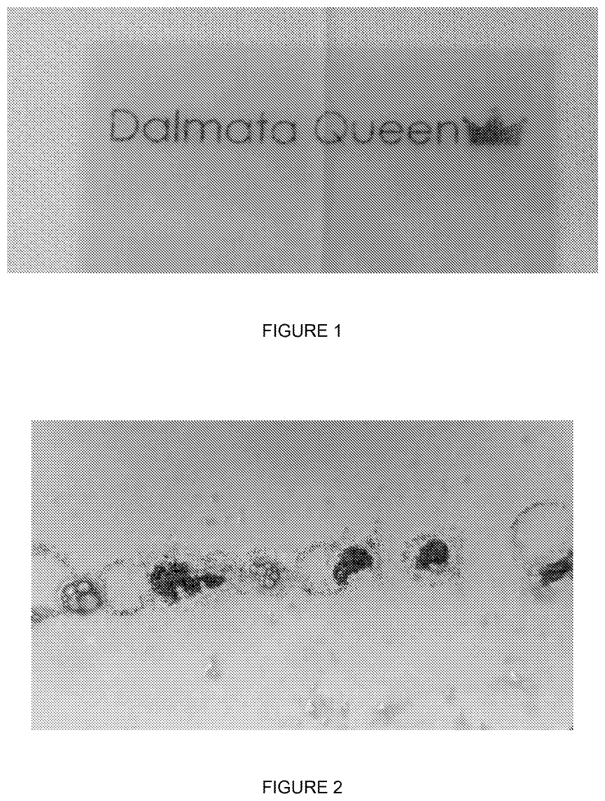

In this Example, a layer of the build material composition of Example 1 was printed over the entirety of the print substrate bearing a “Dalmata Queen” label as shown in FIG. 1. The heating agent of Example 2 was printed in between the letters of the upper “Dalmata Queen” label. The heating agent was then irradiated with infra-red radiation, causing thermal energy to be produced. As can be seen from the enlarged photograph shown in FIG. 2, the heat generated caused the copper salt in the vicinity of the heating agent to be reduced to elemental copper. The degree of resolution of can be controlled by varying the print density of the heating agent.

### Example 3

In this example, a build material compositions having the following composition were prepared:

| CTP composition | I | II | Comparative |
|---|---|---|---|
| Ingredient | % w/w | % w/w | % w/w |
| 2-pyrrolidone | 7.5 | 7.75 | |
| Alkyldiphenyloxide Disulfonate | 0.5 | | |
| (Dowfax ™ 2A1 supplied by Dow ® | | | |
| Chemical) | | | |
| Non-ionic fluorinated surfactant | 0.025 | | |
| (Capstone FS-35 supplied by | | | |
| ChemPoint ®) | | | |
| Cu(NO₃)₂ · 3H₂O | 40.0 | 40.0 | 40.0 |
| H₂O | Balance | Balance | Balance |

Each composition was applied onto a glass substrate and heated from room temperature to at least 125 degrees C.

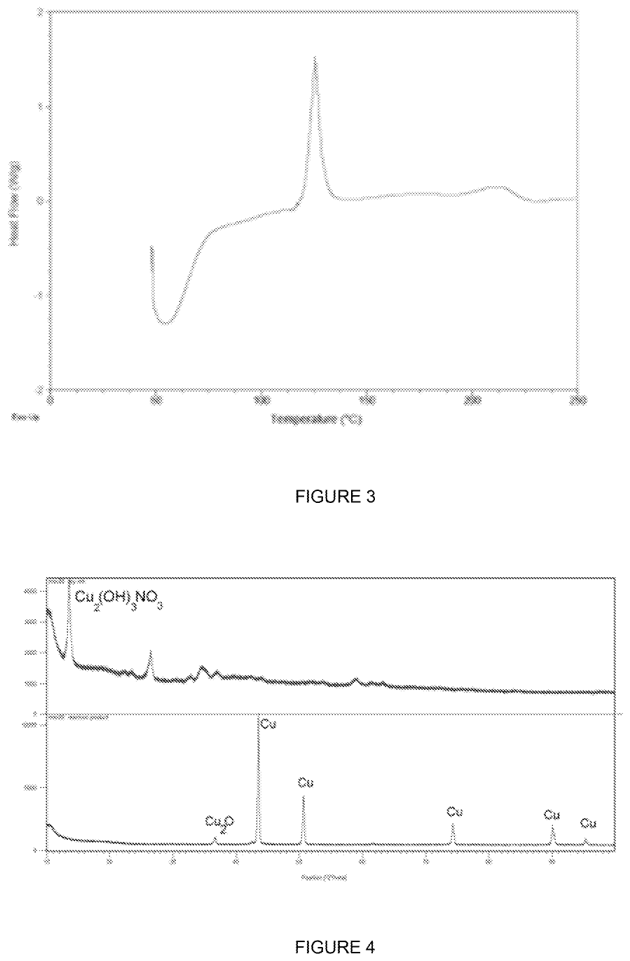

With compositions I and II, an exothermic reaction occurred, causing the copper (II) ions in solution to be reduced to copper (0), leaving an elemental copper trace. An exotherm was observed when the reaction was analyzed by differential scanning calorimetry (DSC). See FIG. 3. The formation of copper was also confirmed by x-ray diffraction. As shown in FIG. 4, no copper (0) peaks were observed with the composition I prior to heating. However, after heating, copper (0) peaks were observed.

### Example 4

In this Example, compositions consisting of 40.0 weight % Cu(NO₃)₂·3H₂O, water and 2-12 weight % of the reducing solvents shown in Table 1 below were prepared. The compositions were applied onto a glass substrate and heated from room temperature to at least 125 degrees C. The heating process was analyzed by differential scanning calorimetry (DSC) to determine the presence or absence of an exotherm. The heated samples were examined for the presence of copper(0) by visual inspection or x-ray diffraction. The results are shown in Table 1 below.

TABLE 1

| | | | Conductive |
|---|---|---|---|
| | | | Trace |
| Sample | Reducing Solvent (amount wt %) | Exotherm? | formed? |
| A | Ethylene Glycol (12 wt %) | Yes | Yes |
| B | Propylene Glycol (12 wt %) | Yes | Yes |
| C | Glycerol (12 wt %) | Yes | Yes |
| D | Glycerol Ethoxylate (12 wt %) | Yes | Yes |
| E | Ethylhydroxypropanediol (12 wt %) | Yes | Yes |
| F | 1,2-butanediol (7.5 wt %) | Yes | Yes |
| G | Diethyleneglycol (12 wt %) | Yes | Yes |
| H | Dipropyleneglycol (7.5 wt %) | Yes | Yes |
| I | 2-pyrrolidinone (2, 4, 10 wt %) | Yes | Yes |
| J | 1-hydroxyethyl-2-pyrrolidinone | Yes | Yes |
| | (7.5 wt %) | | |
| K | Polyvinylpyrrolidone (7.5 wt %) | Yes | Yes |
| L | 1-pentanol (7.5 wt %) | No | No |
| M | 1-butanol (7.5 wt %) | No | No |

### Definitions

It is noted that, as used in this specification and the appended claims, the singular forms “a,” “an” and “the” include plural referents unless the content clearly dictates otherwise.

As used herein, the term “about” is used to provide flexibility to a range endpoint by providing that a given value may be “a little above” or “a little below” the endpoint. The degree of flexibility of this term can be dictated by the particular variable and can be determined based on experience and the associated description herein.

As used herein, a plurality of items, structural elements, compositional elements, and/or materials may be presented in a common list for convenience. However, these lists should be construed as though each individual member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if the numerical value and sub-range is recited. For example, a weight ratio range of about 1 wt % to about 20 wt % should be interpreted to include the explicitly recited limits of 1 wt % and about 20 wt %, and also to include individual weights such as 2 wt %, 11 wt %, 14 wt %, and sub-ranges such as 10 wt % to 20 wt %, 5 wt % to 15 wt %, etc.

As a further note, in the present disclosure, it is noted that when discussing the fluids, materials, and methods described herein, these discussions can be considered applicable to the various examples, whether or not they are explicitly discussed in the context of that example. Thus, for example, in discussing details about the methods of making 3D printed objects, such discussion also refers to the 3D printing kits, and vice versa.

Where selective jetting of an agent is performed based on a 3D object model, the 3D object model may comprise at least one of: a 3D object model created using Computer Aided Design (CAD) or similar software; or a file, for example, a Standard Tessellation Language file generated based on output of the CAD software, providing one or more processors of a 3D printer with instructions to form the 3D object

1. A method of 3D printing a 3D printed object, said method comprising
printing a layer of a build material composition comprising a solution of a metal salt and a liquid carrier;
forming an interconnected metal network by reducing the metal salt in the printed build material composition;
printing a further layer of the build material composition over the interconnected metal network, and
reducing the metal salt in the further layer to form a further interconnected metal network over the underlying interconnected metal network to provide a porous structure to the 3D printed object.

2. The method of claim 1, wherein the metal salt is a copper nitrate.

3. The method of claim 1, wherein the build material composition comprises a reducing agent.

4. The method of claim 3, wherein the reducing agent is present in an amount of 1 to 20 weight % of the build material composition.

5. The method of claim 3, wherein the reducing agent is 2-pyrrolidinone.

6. The method as claimed in claim 1, wherein reduction of the metal salt is initiated by heating the printed build material composition to a temperature of about 100 to about 300° C.

7. The method as claimed in claim 1, which comprises:
applying a heating agent over or adjacent to at least one of the layers of printed build material composition, said heating agent comprising a radiation absorber and a liquid carrier; and
irradiating the applied heating agent with electromagnetic radiation to cause the radiation absorber to generate heat for the reduction of metal salt.

8. The method as claimed in claim 7, wherein the heating agent is selectively applied over a portion of at least one of the layers.

9. The method as claimed in claim 1, wherein the metal salt is reduced in the presence of oxygen.

10. The method as claimed in claim 10, wherein the presence of oxygen causes at least some of the metal in the interconnected metal network to oxidise as or after the metal salt is reduced.

11. The method as claimed in claim 11, which further comprises thermally treating the interconnected metal network to reduce any metal oxide to metal.

12. The method as claimed in claim 1, wherein the porosity of the 3D printed object is controlled by controlling the print density of the build material composition in each layer of printed build material composition.

13. The method as claimed in claim 1, which further comprises incorporating material to at least partially fill the porous structure.

14. A 3D printed object obtainable by a process as claimed in claim 1.

15. A build material composition comprising a metal salt;
3 to 15 weight % of a reducing solvent selected from a lactam and/or a polyol, and
water,
wherein, where the reducing solvent is 2-pyrrolidinone, the 2-pyrrolidinone is not present in an amount of 5 weight % or in an amount of 7.5 weight % of the build material composition.
